(19) United States
(12) Patent Application Publication
(10) Pub. No.: US 2015/0368113 A1
(43) Pub. Date: Dec. 24, 2015

(54) METHOD FOR CONTINUOUSLY PREPARING SILICON NANOPARTICLES, AND ANODE ACTIVE MATERIAL FOR LITHIUM SECONDARY BATTERY COMPRISING SAME

(71) Applicant: KCC CORPORATION, Seocho-gu, Seoul (KR)

(72) Inventors: Yeon Seok CHO, Gyeonggi-do (KR); Kyoung Hoon KANG, Gyeonggi-do (KR); Jin Seok SEO, Gyeonggi-do (KR); Tae Wook LIM, Seoul (KR)

(73) Assignee: Kcc Corporation

(21) Appl. No.: 14/765,899

(22) PCT Filed: Feb. 4, 2014
(86) PCT No.: PCT/KR2014/000933

§ 371 Date: Aug. 5, 2015

(30) Foreign Application Priority Data
Feb. 5, 2013 (KR) 10-2013-0012967

(51) Int. Cl. C01B 33/03; C01B 33/029; H01M 4/36; H01M 4/587; H01M 4/38; H01M 10/052

(52) U.S. Cl. CPC C01B 33/03; H01M 4/386; H01M 10/052; H01M 4/366; H01M 4/587; C01B 33/029; C01P 2004/64; C01P 2004/50

(57) ABSTRACT

This invention relates to a method of manufacturing silicon nanoparticles, wherein the deterioration of an electrode due to the volume change of silicon can be minimized and electrical contact can be improved, thus ensuring high capacity and cycle characteristics of a battery, and to an anode active material using silicon nanoparticles manufactured thereby. The method of continuously manufacturing silicon nanoparticles includes feeding a silane gas and a carrier gas into a reactor, decomposing the silane gas in the reactor, and recovering the silicon nanoparticles.

### BACKGROUND OF THE INVENTION

1. Field of the Invention

The present invention relates to a method of manufacturing silicon nanoparticles and an anode active material for a lithium secondary battery using silicon nanoparticles manufactured thereby, and more particularly, to a method of manufacturing silicon nanoparticles having a particle size of 5 to 100 nm through the decomposition of a silane gas precursor and to an anode active material for a lithium secondary battery using silicon nanoparticles manufactured thereby.

2. Description of the Related Art

Mobile electronic and communication devices are being rapidly developed as they are manufactured to be small and light and to have high performance. Mainly adopted as the power source thereof is a lithium secondary battery, which is simple to use. Hence, in order to emphasize the mobile features of such electronic and communication devices, the development of a high-capacity lithium secondary battery having high energy density is required. A lithium secondary battery, which operates through the repetition of charge and discharge based on the intercalation and deintercalation of lithium ions, is considered to be more broadly useful as a power supply not only for portable electronic devices such as mobile phones, notebook computers, etc., but also for medium- or large-sized systems, such as electric vehicles and energy storage systems.

Improvements in performance of the lithium secondary battery are fundamentally dependent on enhancing the performance of four elements thereof, namely an anode, a cathode, a separator, and an electrolyte. In particular, high performance of the anode is focused on the development of a high-capacity lithium secondary battery having high energy density by increasing the charge and discharge capacity of lithium ions per unit volume through the development of an anode material. Currently useful as the anode active material for a lithium ion battery is a carbon-based material. Examples of the carbon-based material include crystalline carbon, such as natural graphite and artificial graphite, and amorphous carbon, such as soft carbon and hard carbon. However, the upper limit of the theoretical capacity of a typical carbon-based anode material, graphite, has been determined to be about 372 mAh/g, and thus a novel high-capacity anode material is required in order to develop a high-capacity lithium secondary battery.

With the goal of solving such problems, thorough research into a metal-based anode active material is currently ongoing. For example, lithium secondary batteries using metal or semi-metal such as silicon (Si), tin (Sn), aluminum (Al), germanium (Ge), lead (Pb), and zinc (Zn) as the anode active material are under active study. Such a metal-based anode active material is appropriate for manufacturing batteries having high capacity and high energy density because it enables reversible alloying and dealloying reactions with many lithium ions compared to the carbon-based anode active material. Silicon in particular is a material having a high theoretical capacity of about 4,200 mAh/g.

However, silicon has poor cycle characteristics compared to the carbon-based anode active material and the actual application thereof is difficult. The reason is that in the charge and discharge processes, namely, in a charge process and a discharge process for alloying and dealloying silicon with lithium ions, respectively, silicon undergoes a volume change of about 400%, thereby generating mechanical stress, which then causes cracking on the inside and the surface of the silicon anode. When such charge and discharge cycles are repeated, the silicon anode active material is delaminated from the current collector, and electrical insulation may be caused due to cracking in the silicon anode active material, undesirably drastically shortening the lifetime of the battery.

In this regard, Japanese Patent Application Publication No. 1994-318454 discloses an anode material prepared by simply mixing metal or alloy particles with a carbon-based active material that enables the alloying and dealloying with lithium ions. In this case, however, there still remains the problem of remarkably shortening the lifetime of the battery, in which the metal-based active material is crushed and finely powdered, attributable to the excessive volume change thereof during the charge and discharge processes, whereby the powdered particles are delaminated from the current collector.

The silicon powder disclosed in Japanese Patent Application Publication No. 1994-318454 has a particle size ranging from ones of μm to hundreds of μm, making it difficult to avoid mechanical stress due to the volume change caused by the charge and discharge of the battery.

Meanwhile, silicon nanoparticles are known to be manufactured using a silicon metal target by a laser beam or sputtering, or through thermal decomposition of a silicon-containing precursor using UV light in a solvent. In order to reduce the effect of mechanical stress, the silicon particles have to possess a small size. In order to continuously manufacture silicon particles having a predetermined size as desired in the size range of 100 nm or less, a bottom-up process for decomposing a silane precursor to grow particles to a desired particle size from an atomic unit is regarded as appropriate, rather than a top-down process for manufacturing small particles from a metal target or large particles on a macro scale. Furthermore, the use of laser or plasma is unsuitable in terms of mass production or costs, and the solvent process is also unsuitable for continuous production and incurs high costs.

### PRIOR ART REFERENCE

Japanese Patent Application Publication No. 1994-318454

U.S. Pat. No. 5,695,617

U.S. Patent Application Publication No. 2006/0049547 A1

U.S. Patent Application Publication No. 2010/0147675 A1

U.S. Patent Application Publication No. 2006/0042414 A1

U.S. Pat. No. 5,850,064

U.S. Pat. No. 6,974,493 B2

### SUMMARY OF THE INVENTION

Accordingly, the present invention has been made keeping in mind the above problems encountered in the related art, and an object of the present invention is to provide a method of manufacturing silicon nanoparticles, wherein the deterioration of an electrode due to the volume change of silicon may be minimized and electrical contact may be improved, thus ensuring high capacity and cycle characteristics of batteries, and an anode active material using the nanoparticles manufactured thereby.

In order to accomplish the above object, the present invention provides a method of manufacturing silicon nanoparticles, as described below.

A method of continuously manufacturing silicon nanoparticles comprises: feeding a silane gas and a carrier gas into a reactor; decomposing the silane gas in the reactor, thus obtaining silicon nanoparticles; and recovering the silicon nanoparticles.

The present inventors reduced the size of silicon particles to the level of ones of nm, in order to avoid the volume expansion of silicon particles that react with lithium and mechanical cracking due to the volume change upon dealloying.

To this end, in the present invention, silicon nanoparticles are continuously manufactured through the decomposition of a silane gas precursor. The silane gas precursor is exemplified by a chlorosilane gas, a monosilane gas, or a silicon-containing halogen compound (HₐSiX_{b}, a=0 to 4, b=4˜a, X═Cl, Br, I, F). While this gas is fed alone or together with hydrogen gas into a column reactor at a predetermined temperature and passes through the predetermined temperature zone in the column, the silane gas precursor is decomposed, thus obtaining silicon nanoparticles (Reactions 1 and 2).

[Reaction 1]

Decomposition of Monosilane: SiH₄=Si+2H₂

[Reaction 2]

Thermal decomposition of Trichlorosilane: HSiCl₃+H₂═Si+3HCl

The silicon nanoparticles thus obtained are collected using an appropriate separation unit. In the present invention, the silicon nanoparticles, which are formed in the course of decomposition of the silane gas, may be obtained as the byproduct during the preparation of polysilicon using monosilane, trichlorosilane, or dichlorosilane. For example, in a Siemens process for preparing polysilicon using monosilane or a fluidized bed reaction process for preparing granular silicon, bulky polysilicon may result from the heterogeneous deposition of monosilane, and additionally, silicon nanoparticles are obtained as a product that is usable as the anode active material through homogeneous deposition. Briefly, the silicon nanoparticles may be obtained as the byproduct in the process of preparing bulky polysilicon.

In particular, the silicon nanoparticles prepared by the fluidized bed reaction process are composed mainly of particles resulting from the homogeneous reaction in a bubble phase formed in the fluidized bed, and are classified into primary particles, formed during the decomposition of gas, and secondary particles, formed by the agglomeration of primary particles. The size of the primary particles ranges from ones of nm to tens of nm depending on the preparation conditions, and should be 50 nm or less. The secondary particles have a size ranging from tens to hundreds of nm by virtue of the formation of the simple structure of the primary particles, as illustrated in FIG. 2. Such secondary particles are agglomerated again or grown, thus forming particles having a size ranging from hundreds of nm to tens of μm. The size of the particles suitable for use in a lithium secondary battery is set to the range of hundreds of nm or less, and preferably 100 nm or less, corresponding to the size of the relatively small secondary particles, as illustrated in FIG. 2.

If the silicon particles are too small, it is difficult to disperse them in the subsequent procedure for forming an anode using a coating process. In contrast, if the silicon particles are too large, the anode may deteriorate attributable to mechanical stress in the charge and discharge processes. For this reason, the size of the silicon nanoparticles is preferably set within the above range.

The size of the manufactured silicon nanoparticles may be adjusted depending on the mixing ratio of silane gas and carrier gas. Examples of the carrier gas may include H₂, N₂, Ar, HCl, and Cl₂.

The reaction temperature for decomposition of the silane as is preferably 500 to 1,200° C., and is appropriately set under the deposition conditions depending on the kind of silane gas. For example, the silane gas is thermally decomposed when the reaction temperature is 600 to 800° C. for monosilane, 600 to 900° C. for dichlorosilane, or 700 to 1,100° C. for trichlorosilane. The reaction temperature is an important factor of the polysilicon preparation mechanism, and has an influence on the deposition amount and the control of homogeneous and heterogeneous reactions. Hence, adjusting the optimal temperature of the fluidized bed and the distribution thereof is regarded as important in order to increase the productivity and efficiency of the reactor.

The lower limit of the above reaction temperature is the thermal decomposition temperature of the corresponding material. If the reaction temperature exceeds the upper limit, the rate decomposition of the precursor may increase, and thus the rates of production and agglomeration of the particles may increase. Accordingly, the particles are not densely deposited, undesirably forming gaps or generating pores. Furthermore, as the temperature of the reactor is raised, energy consumption may increase, thus negating economic benefits. Hence, it is preferred that the upper limit of the reaction temperature be determined.

In addition to the kind of silane gas and the decomposition temperature, the concentration of silane gas contained in the fed gases is also important when producing the silicon nanoparticles. Depending on the concentration of silane gas, the appearance of the manufactured silicon nanoparticles may vary. As such, the molar ratio of silane gas and carrier gas is preferably 1:1 or more, and more preferably ranges from 1:30 to 1:4, thus forming uniform silicon nanoparticles.

In some situations, secondary particles suitable for use in a lithium secondary battery need to be collected depending on the size. To this end, useful are a cyclone, a filter, and an electrostatic precipitator, which function to remove or recover powder from the exhaust gas of a typical powdering process. In particular, the use of a filter or an electrostatic precipitator is preferable rather than a cyclone, based on the size of the particles collected by each device. The construction and principle of cyclone, filter, or electrostatic precipitator for recovering silicon nanoparticles are typical in the fields of polysilicon and powdering processes and thus may be easily realized by those skilled in the art, and any one of the above devices may be utilized in the present invention.

The silicon nanoparticles obtained by thermal decomposition of silane gas according to the present invention have a size of ones of nm. For example, when silicon nanoparticles having a size of about 5 to 100 nm are used as the anode active material, it is possible to avoid mechanical stress attributable to rapid volume expansion or contraction due to coupling and decoupling of lithium ions in the processes of charging and discharging a lithium secondary battery. Therefore, the use of such particles as the anode material, for a lithium secondary battery may solve the problems, including low cycle characteristics, short lifetime, etc.

Meanwhile, the purity of the manufactured silicon nanoparticles is a factor that greatly affects the performance when used as the anode active material. Examples of impurities that affect the purity include metal materials such as iron (Fe), nickel (Ni), chromium (Cr) and aluminum (Al), nonmetal materials such as boron (B) and phosphorus (P), and chlorine (Cl), hydrogen (H) and carbon (C), which may be fed from the feed gas. All of these materials are used in polysilicon for generally known solar photovoltaic applications.

In particular, the metal such as Fe, Ni, Cr, Al may be present in a wide concentration range from ones of ppba to hundreds of ppma, and preferably, the concentration thereof should be maintained in the range of 1 ppba to 50 ppma. The nonmetal such as B or P may be present in the concentration range from ones of ppba to hundreds of ppba, and preferably, the concentration thereof should be maintained within the range of 0.1 to 100 ppba. As the impurity that may be fed from the feed gas, chlorine (Cl) or hydrogen (H) may be coupled with lithium to form a compound. As such, it should be noted that the amount of the impurity should be checked because it may significantly reduce the battery efficiency. Although such an impurity may be present in the range from ones of ppba to hundreds of ppma, the amounts of chlorine and hydrogen should be 100 ppma or less and 50 ppma or less, respectively.

In addition, the present invention addresses an anode active material configured such that the uniform silicon nanoparticles are coated with conductive carbon or silicon oxide. It may be formed by selecting an appropriate organic polymer, coating the silicon nanoparticles therewith, and then performing burning, or by adding oxygen upon the thermal decomposition of monosilane. Conductive carbon or silicon oxide exhibits low volume change, and functions to properly disperse the silicon nanoparticles and also to confine the silicon nanoparticles in a small space, whereby the particles are not delaminated through powdering due to the volume change thereof. Thus, electric shorts attributable to the powdering of the silicon particles may be prevented, ultimately improving the cycle characteristics of the battery.

The anode active material according to the present invention includes silicon particles having a size of about 5 to 100 nm, and enables the initial battery capacity to be maintained even when the charge and discharge cycles of the battery are carried out. The anode active material may further include a conductive carbon material or a silicon oxide compound, in addition to the silicon nanoparticles. The carbon-based anode active material may be used without limitation so long as it is known in the art, and examples thereof may include crystalline carbon such as natural graphite or artificial graphite, amorphous carbon such as soft carbon or hard carbon, and silicon oxide, which may be used alone or in combination of two or more. In silicon oxide (SiOx), x equals 0.2 to 1.8.

Also, the silicon nanoparticles and the carbon-based anode active material or silicon oxide may be mixed through mechanical processing such as ball milling, or may be stirred in a solvent using a dispersant, or may be mixed using ultrasonic waves, but the present invention is not limited to these methods.

In addition, the present invention addresses an anode material for a lithium secondary battery, comprising the anode active material, a conductive material and a binder, and also addresses an anode for a lithium secondary battery, formed by applying the anode material on an anode current collector.

The conductive material, which is contained in the anode material, functions to increase the total conductivity of the anode material and to improve the output characteristics of the battery. Furthermore, it plays a role as a buffer for suppressing the volume expansion of the silicon particles. The conductive material may be used without particular limitation so long as it has high electrical conductivity and causes no side reactions in the lithium secondary battery. Preferably useful is a carbon-based material having high conductivity, for example, graphite or conductive carbon. In some situations, a conductive polymer having high conductivity may be used. Specifically, graphite may include, but is not particularly limited to, natural graphite or artificial graphite. The conductive carbon preferably includes a carbon-based material having high conductivity, and a specific example thereof may include any one or a mixture of two or more selected from the group consisting of carbon black, such as carbon black, acetylene black, Ketjen black, furnace black, lamp black, and summer black, and materials having a graphene or graphite crystal structure. Also, any precursor for the conductive material may be used without particular limitation so long as it can be converted into a conductive material through burning at a relatively low temperature in an oxygen-containing atmosphere, for example, in air. The process of adding the conductive material is not particularly limited, and any typical process known in the art, including coating of the anode active material therewith, etc., may be adopted. The conductive material is preferably added to the extent that the silicon particles are sufficiently filled so as to densely form an anode material without gaps using the silicon particles.

The binder may be used without limitation so as long it is known in the art. For example, polyvinylidene fluoride (PVDF), polyacrylonitrile, polymethylmethacrylate, and a vinylidene fluoride/hexafluoropropylene copolymer may be used alone or in combination of two or more. The binder is used in as small an amount as possible. However, if the amount of the binder is too small, its binding action is not exhibited. In contrast, if the amount thereof is too large, the amounts of the silicon particles and the conductive material are relatively decreased. In consideration thereof, the binder is added in a suitable amount.

The process of manufacturing the anode is not particularly limited. For example, the anode is manufactured in a manner such that the anode active material, the conductive material, the binder, and the solvent are mixed, thus preparing a slurry, after which the slurry is applied on the anode current collector, such as copper, and then dried. As such, a filler may be added to the above mixture, as necessary.

In addition, the present invention addresses a lithium secondary battery, comprising an anode, a cathode, a separator, and an electrolyte. Generally, a lithium secondary battery includes an anode comprising an anode material and an anode current collector, a cathode comprising a cathode material and a cathode current collector, and a separator interposed between the anode and the cathode so that the cathode and the anode do not come into physical contact with each other to thereby prevent a short, and additionally so that lithium ions pass therethrough to thereby enable electrical conduction. Furthermore, the empty space of the anode, the cathode and the separator is filled with an electrolyte to enable the electrical conduction of lithium ions. The process of forming the cathode is not particularly limited. For example, the cathode may be manufactured by drying a cathode active material, a conductive material, a binder, and a solvent. As such, a filler may be added to the above mixture, as necessary.

The lithium secondary battery according to the present invention may be manufactured by a typical method useful in the art. For example, the lithium secondary battery may be manufactured by disposing a porous separator between the anode and the cathode and then introducing an electrolyte containing lithium ions.

According to the present invention, the lithium secondary battery is preferably utilized as a battery cell that is useful for power sources of small devices such as mobile phones, and as the unit cell of medium- or large-sized battery modules including battery cells. Examples of the medium- or large-sized devices may include power tools; electric vehicles, including electric vehicles (EVs), hybrid electric vehicles (HEVs), and plug-in hybrid electric vehicles (PHEVs); electric two-wheelers, including E-bikes and E-scooters; electric golf carts; electric trucks; electric commercial vehicles; and power storage systems.

According to the present invention, silicon nanoparticles can be effectively manufactured. In particular, silicon nanoparticles are obtained from the byproduct of a polysilion preparation process, thereby efficiently utilizing resources and reducing the manufacturing cost.

Also, when the manufactured silicon nanoparticles are used as the active material for a lithium secondary battery, they undergo only slight volume change in the charge and discharge processes, thus relieving mechanical stress, ultimately increasing the capacity of the battery and exhibiting superior cycle characteristics thereof.

### BRIEF DESCRIPTION OF THE DRAWINGS

The above and other objects, features and advantages of the present invention will be more clearly understood from the following detailed description taken in conjunction with the accompanying drawings, in which:

FIG. 1 schematically illustrates an apparatus for manufacturing silicon nanoparticles according to the present invention; and

FIG. 2 illustrates an electron microscope image of the silicon nanoparticles manufactured according to the present invention.

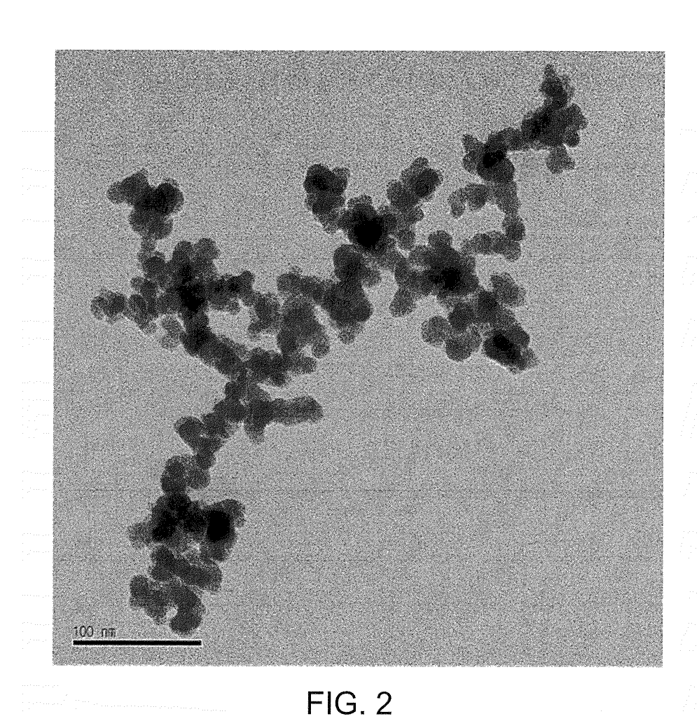

### DESCRIPTION OF SPECIFIC EMBODIMENTS

Hereinafter, a detailed description will be given of preferred embodiments of the present invention through the following examples. However, these examples are merely illustrative, but are not construed as limiting the scope of the present invention.

<Preparation of Silicon Nanoparticles>

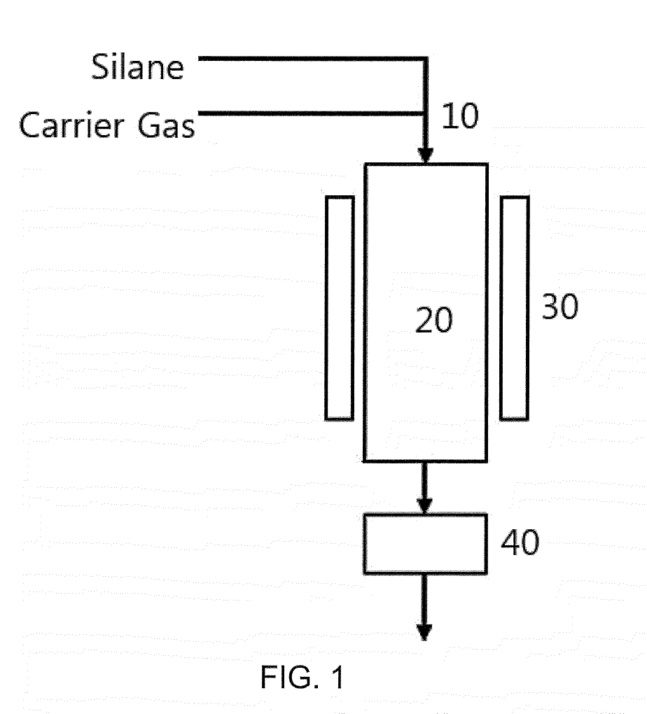

Using the apparatus illustrated in FIG. 1, silicon nanoparticles may be manufactured, but the construction of the manufacturing apparatus, the gas introduction process, and the heating process are not particularly limited.

1-1. Preparation of Silicon Nanoparticles Using Monosilane Gas

A monosilane gas and hydrogen gas as a carrier gas were fed at respective flow rates of 16.7 g/min and 4.5 g/min into a column reactor 20 via a gas inlet 10 of the apparatus of FIG. 1. The column reactor 20 was heated to 650° C. using a heater 30. In the reactor 20, the monosilane gas was decomposed and thus converted into silicon nanoparticles, and then emitted together with the carrier gas from the column reactor 20. Subsequently, the silicon nanoparticles were collected by a powder collection unit 40, and unreacted silane and hydrogen gas were treated using a waste gas processing unit after having passed through a powder filtration unit. The unreacted gas and the hydrogen gas, which had been passed through the powder collection unit, were quantitatively analyzed using a gas chromatograph, and the conversion rate and the like were calculated. The conversion rate of the monosilane gas was 95 to 99%. The size of secondary particles resulting from agglomeration of the silicon nanoparticles collected by the collection unit fell in the range of 10 to 20 μm. The amount of the silicon nanoparticles produced through a reaction for 1 hr was 831 to 866 g/h. Meanwhile, in order to collect the silicon nanoparticles, the recovery rates were compared using a cyclone, a filter and an electrostatic precipitator. The silicon particles were recovered at the level of 50 to 70% using the cyclone, 99% or more using the filter, and 90% or more using the electrostatic precipitator. The size of the recovered silicon nanoparticles fell in the range of 20 to 50 nm. The secondary particles obtained by agglomeration of the silicon nanoparticles were separated so as to attain silicon nanoparticles using an appropriate dispersion process upon the preparation of an anode active material.

1-2. Conversion Rate of Monosilane Depending on Reaction Temperature

Under the conditions of 1-1, the column reactor was maintained at temperatures of 400, 500, 600, 700, and 800° C., and the conversion rates of monosilane were measured. The conversion rate of monosilane was calculated from the amount of unreacted monosilane on the gas chromatograph relative to the amount of added monosilane. The monosilane was decomposed to 95% or more at a temperature of 600° C. or higher, yielding silicon nanoparticles having a primary size ranging from 5 to 100 nm.

1-3. Control of Size of Silicon Nanoparticles

Under the conditions of 1-1, the ratio of added monosilane and hydrogen gas as the carrier gas was adjusted, thus controlling the size of the silicon nanoparticles. With respect to the ratio of added monosilane and hydrogen gas, hydrogen gas was adjusted to 70 to 98 mol % relative to monosilane in the range of 30 to 2 mol %. As the proportion of the monosilane gas was lower, the size of the silicon nanoparticles was reduced. The size of the silicon nanoparticles was 50 to 100 nm at the molar ratio of hydrogen gas and monosilane gas of 70:30, and was 5 to 20 nm at the molar ratio of 98:2.

2-1. Preparation of Silicon Nanoparticles Using Trichlorosilane

Trichlorosilane and hydrogen gas as a carrier gas were fed at respective flow rates of 72.58 g/min and 4.29 g/min into a column reactor heated to 700 to 800° C. In the column reactor, trichlorosilane was decomposed and thus converted into silicon nanoparticles, after which such nanoparticles were transported into a separation unit together with the carrier gas. Then, the silicon nanoparticles were collected, and unreacted trichlorosilane and hydrogen were treated using a waste gas processing unit after having passed through a collection unit. The conversion rate of trichlorosilane was 50 to 90%, and silicon particles having a size ranging from 10 to 20 μm collected by a filtration unit were produced in an amount of 450 to 810 g/h through a reaction for 1 hr. The primary size of the collected silicon nanoparticles fell in the range of 20 to 50 nm.

2-2. Control of Size of Silicon Nanoparticles

Under the conditions of 2-1, the ratio of added trichlorosilane and hydrogen was adjusted, thus controlling the size of the silicon nanoparticles. The amount of added trichlorosilane was adjusted from 30 mol % to 2 mol % relative to the amount of hydrogen. As the proportion of trichlorosilane was lower, the size of the silicon nanoparticles was reduced. The size of the silicon nanoparticles was 50 to 120 nm at the molar ratio of hydrogen and trichlorosilane of 70:30, and was 5 to 30 nm at the molar ratio of 98:2.

3. Fabrication of Anode and Cathode

The manufactured silicon nanoparticles as an anode active material, a conductive material (Super P Black, SPB) and a binder (polyvinylidene fluoride, PVDF) were mixed at a weight ratio of 75:15:10 (the charge and discharge capacity was a value obtained by calculating the amount of anode active material used, 75%). Specifically, the binder was dissolved in a solvent NMP (N-methylpyrrolidone, 99% Aldrich Co.) for 10 min using a mixer, after which the anode active material and the conductive material were added, and the resulting mixture was stirred for 30 min, thus obtaining a uniform slurry. This slurry was applied on a piece of copper foil using a blade, dried in an oven at 110° C. for 2 hr to evaporate the solvent, and then pressed using a hot press roll. The anode thus obtained was dried in a vacuum oven at 120° C. for 12 hr.

Next, a lithium metal cathode active material, a conductive material (Super P Black, SPB) and a binder (polyvinylidene fluoride, PVDF) were mixed at a weight ratio of 75:15:10. Specifically, the binder was dissolved in a solvent NMP (N-methylpyrrolidone, 99% Aldrich Co.) for 10 min using a mixer, after which the cathode active material and the conductive material were added, and the resulting mixture was stirred for 30 min, thus obtaining a uniform slurry. This slurry was applied on a piece of aluminum foil using a blade, dried in an oven at 110° C. for 2 hr to evaporate the solvent, and then pressed using a hot press roll. The cathode thus obtained was dried in a vacuum oven at 120° C. for 12 hr.

<Fabrication of Lithium Secondary Battery>

The dried anode was cut to a diameter of 1.4 cm, and then used to manufacture a 2016-type coin cell, together with the above cathode and the electrolyte solution obtained by dissolving 1M LiPF₆ in ethylene carbonate (EC)/ethylmethyl carbonate (EMC) (v/v=1/1) and vinylene carbonate (VC, 2 wt %). The entire process for fabricating the battery was performed in a glove box in an argon atmosphere having an inner moisture content of 10 ppm or less.

### COMPARATIVE EXAMPLE

An anode, a cathode, and a lithium secondary battery were manufactured in the same manner as in Example, with the exception that commercially available silicon powder (633097, 98%, Aldrich. Co.) having a particle size of ones of μm was used as the anode active material.

<Comparative Test>

The lithium secondary battery of each of Example and Comparative Example was allowed to stand for 24 hr so as to be stabilized, and was then subjected to charge and discharge testing using WBCS3000L, a battery test system made by Won-A Tech. The charge and discharge were carried out in the voltage range of 0.0 to 1.5 V at a current of 0.14 mA ( 1/20C).

The battery of Example exhibited an anode initial capacity of 1750 mAh/g, whereas the battery of Comparative Example showed an anode initial capacity of 1050 mAh/g, and thus the capacity was higher in Example than in Comparative Example. Based on the results of charge and discharge testing, higher capacity was maintained in Example than in Comparative Example, resulting in superior cycle characteristics and lifetime.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of continuously manufacturing silicon nanoparticles, comprising:
feeding a silane gas and a carrier gas into a reactor;
decomposing the silane gas in the reactor, thus obtaining silicon nanoparticles; and
recovering the silicon nanoparticles.

2. The method of claim 1, wherein a mixing ratio of the silane gas and the carrier gas is a molar ratio ranging from 1:1 to 1:30.

3. The method of claim 2, wherein the mixing ratio of the silane gas and the carrier gas is a molar ratio ranging from 1:4 to 1:30.

4. (canceled)

5. The method of claim 1, wherein the silane gas is any one of monosilane, trichlorosilane, and dichlorosilane, which are used for a fluidized bed reaction process for preparing granular polysilicon.

6. The method of claim 1, wherein the monosilane is thermally decomposed at 600 to 800° C.

7. The method of claim 1, wherein the dichlorosilane is thermally decomposed at 600 to 900° C.

8. The method of claim 1, wherein the trichlorosilane is thermally decomposed at 700 to 1100° C.

9. The method of claim 1, wherein the silicon nanoparticles have a size of 50 nm or less.

10. The method of claim 9, wherein the silicon nanoparticles are agglomerated, thus forming secondary particles having a size of 100 nm or less.

11. The method of claim 1, wherein the recovering the silicon nanoparticles is performed using any one of a cyclone, a filter, and an electrostatic precipitator.

12. Silicon nanoparticles, comprising primary silicon particles having a particle size of 5 to 50 nm; and secondary silicon particles having a particle size of 100 nm or less produced by agglomeration or growth of the primary silicon particles, wherein the silicon nanoparticles contain 50 ppma or less of a metal impurity, 100 ppba or less of a nonmetal impurity, 100 ppma or less of chlorine, and 50 ppma or less of hydrogen.

13. The silicon nanoparticles of claim 12, wherein the metal impurity comprises iron, nickel, chromium, and/or aluminum.

14. The silicon nanoparticles of claim 12, wherein the nonmetal impurity comprises boron and/or phosphorus.

15. An anode active material for a lithium secondary battery, configured such that surfaces of the silicon nanoparticles of claim 12 are coated with a conductive carbon material and/or a silicon oxide compound.

16. The anode active material of claim 15, wherein the conductive carbon material is selected from the group consisting of natural graphite, artificial graphite, soft carbon, and hard carbon.

17. The anode active material of claim 15, wherein in the silicon oxide (SiOx), x equals 0.2 to 1.8.

18. An anode material for a lithium secondary battery, comprising:
the anode active material of claim 15;
a conductive material; and
a binder.

19. An anode for a lithium secondary battery, configured such that the anode material of claim 18 is applied on an anode current collector.

20. A lithium secondary battery, comprising an anode, a cathode, a separator, and an electrolyte, wherein the anode is the anode of claim 19.
